(19) United States
(12) Patent Application Publication
(10) Pub. No.: US 2020/0139321 A1
(43) Pub. Date: May 7, 2020

(54) Low Complexity Flow Control in a Microfluidic Mixer

(71) Applicant: Precision Nanosystems Inc., Vancouver (CA)

(72) Inventors: Andre Wild, Vancouver (CA); Shao Fang Shannon Chang, North Vancouver (CA); Timothy Leaver, Delta (CA)

(73) Assignee: Precision Nanosystems Inc., Vancouver, BC (CA)

(21) Appl. No.: 16/473,490

(22) PCT Filed: Jan. 17, 2018
(86) PCT No.: PCT/CA2018/050053

§ 371 Date: Jun. 25, 2019

Related U.S. Application Data
(60) Provisional application No. 62/447,653, filed on Jan. 18, 2017.

(51) Int. Cl. B01F 13/00; B01F 15/02; B01F 5/24

(52) U.S. Cl. CPC B01F 13/0083; B01F 5/242; B01F 15/02

(57) ABSTRACT

The present invention provides a microfluidic mixing platform having a bulk, the platform including an inlet well, a microchannel, a passive capillary valve a mixing feature and an outlet. The passive capillary valve prevents unwanted capillary flow along the microchannel. The passive capillary valve comprises a widening of the microchannel relative to the direction of fluid flow, and the angle has a graduated profile. The mixing platform bulk comprises a rigid matrix capable of machine manufacture. A method of preventing backflow in a microfluidic mixer is also provided.

### CROSS-REFERENCE TO RELATED APPLICATIONS

Priority is claimed from U.S. Provisional application 62/447,653 filed Jan. 18, 2017.

### BACKGROUND

### (a) Field

The subject matter disclosed generally relates to hydraulics within microfluidic mixing platforms, for use in mixing materials for biological or medical research.

Polydimethylsiloxane (PDMS) has been used in the manufacture of microfluidic mixing platforms for years. It has unique flow properties that make it easy to work with, and it is deemed “safe” for biological substances. However, it is not a preferred material in standard injection molding processes suitable for mass-manufacture.

“Capillary action” is the action of a fluid moving thorough a channel due to forces caused by surface interactions between the fluid and the channel walls, and is consequential when volumes are very small and channels are very narrow. If the diameter of the channel is small enough, then the combination of surface tension (caused by cohesion within the liquid) and adhesive forces between the liquid and container wall propel the liquid, even against gravitational forces.

In prototype PDMS devices, “capillary pumping” of aqueous solutions is inconsequential because PDMS has a “high contact angle”. The contact angle is the angle where a liquid-vapor interface meets a solid surface, and quantifies the wettability of a surface by a liquid. Capillary action (sometimes capillarity, capillary motion, or wicking) is the ability of a liquid to flow in narrow spaces without the assistance of, or even in opposition to, external forces like gravity. The effect can be seen in the drawing up of liquids between the hairs of a paint-brush, in a thin tube, in porous materials such as paper and plaster, in some non-porous materials such as sand and liquefied carbon fiber, or in a cell. It occurs because of intermolecular forces between the liquid and surrounding solid surfaces.

For scale-up production of microfluidic mixing platforms for microfluidic mixers, it was necessary to change the construction material from PDMS. The “contact angle” is lower for materials suitable for mass manufacture than it is for PDMS, causing unwanted capillary pumping of the reagents through the microchannels prior to pressure being applied. The capillary pumping reduced the quality of the nanoparticles produced because of uncontrolled and suboptimal mixing.

### (b) Related Art

An example of a miniature mechanical valve is taught in U.S. Pat. No. 6,431,212. This patent describes a valve manufactured from a flexible layer that allows one-way flow through microfluidic channels for directing fluids through a microfabricated analysis cartridge. This type of valve, however, is difficult to manufacture due to its extremely small dimensions and complexity, and is not practical for scale up.

A nonmechanical means to control fluid movement in microfluidic channels was proposed in U.S. Patent Publication No. 20020003001 by Klein and Weigl. This publication discloses a surface tension-controlled valve for microfluidic diagnostic and analytic purposes, but does not clearly describe the materials and design to achieve them.

The concepts above were not applicable to the present situation because of the manufacturing methods required. The scale of manufacture prevented the application of a known solution.

### SUMMARY

According to embodiments of the invention, there is provided a microfluidic mixing platform having a bulk, including an inlet well, a microchannel having a length, a passive capillary valve at a point in said length, a mixing feature, and an outlet, and wherein said passive capillary valve prevents capillary flow along the microchannel. In embodiments, the bulk comprises a rigid matrix capable of machine manufacture.

In embodiments, the passive capillary valve comprises a widening of the microchannel at an angle of at least 90 degrees and up to 179 degrees relative to the direction of overall fluid flow in the microchannel. In other embodiments, the widening of the microchannel is at an angle of at least 95 degrees and up to 160 degrees relative to the direction of overall fluid flow in the microchannel. In yet other embodiments, the widening of the microchannel is at an angle of at least 100 degrees and up to 150 degrees relative to the direction of fluid flow. In still other embodiments, the widening of the microchannel is at an angle of at least 105 degrees and up to 145 degrees relative to the direction of fluid flow. In other embodiments, the widening of the microchannel is at an angle of at least 110 degrees and up to 140 degrees relative to the direction of fluid flow. In further embodiments, the widening of the microchannel is at an angle of at least 120 degrees, and up to 130 degrees relative to the direction of fluid flow.

In embodiments of the invention, the passive capillary valve is a widening of the microchannel relative to the direction of fluid flow, and wherein said angle is graduated and has a minimum radius of curvature of from 0.015 to 0.05 mm. In other embodiments, the angle is graduated and has a minimum radius of curvature of about 0.08 mm.

In embodiments, the passive capillary valve is singular on the mixing platform. In embodiments, it is plural.

In embodiments, the passive capillary valve is upstream from a mixing feature. In other embodiments, the passive capillary valve is downstream from a mixing feature. In other embodiments, the passive capillary valve is upstream from a mixing feature.

According to embodiments of the invention, there is provided a method of preventing back flow in a microfluidic mixing platform, by incorporating a segment of negative microchannel wall at a point in a microchannel.

In embodiments, said segment of negative microchannel is present once on the microfluidic platform. In other embodiments, twice. In still other embodiments, three times. In still other embodiments, four or more times.

In embodiments, the segment of negative microchannel wall is upstream from a mixing feature. In other embodiments, the segment of negative microchannel wall is downstream from a mixing feature. In embodiments, it may be both up and downstream.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature, and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1a illustrates a top plan view of another embodiment of the passive capillary valve;

FIG. 1b illustrates a side plan view of the same embodiment as in FIG. 1a;

FIG. 1c is a perspective view of the passive capillary valve of FIGS. 1a and 1b;

FIG. 2a illustrates a top plan view of another embodiment of the passive capillary valve;

FIG. 2b illustrates a side plan view of the same embodiment as in FIG. 2a;

FIG. 2c is a perspective view of the passive capillary valve of FIGS. 2a and 2b;

FIG. 3a illustrates a top plan view of another embodiment of the passive capillary valve;

FIG. 3b illustrates a side plan view of the same embodiment as in FIG. 3a;

FIG. 3c is a perspective view of the passive capillary valve of FIGS. 3a and 3b;

FIG. 4a illustrates a top plan view of a passive capillary valve showing exemplary dimensions in millimeters and minimum angle of radius;

FIG. 4b is a side plan view of the same embodiment, showing the passive capillary valve;

FIG. 5 is a top plan illustration of one application of embodiments of the invention in the context of a mixing platform; and

FIG. 6 is a top plan illustration of another application of embodiments of the invention in the context of a mixing platform.

Throughout the appended drawings, like features are identified by like reference numerals.

### DETAILED DESCRIPTION

The following terms, parts, and any reference numbering are now described, followed by details on now the parts go together referencing the drawings, followed by a description of how embodiments of the invention are used

The term “bulk” 70 is used herein to describe the solid form from which the microchannels, inlets, mixing region(s), outlets, and passive capillary valves are formed.

Downstream and upstream in this application are intended to denote direction of fluid flow in a microchannel from an inlet or input location toward an exit or drawing-off point.

Injection molding is the standard method of manufacture for many plastics. A metal block, preferably composed of chromium steel, is machined to the desired shape. A round cutter blade is used. In micromachining applications, the size of the cutter must be very small, but with decrease in size comes a decrease in durability. A 0.3 mm cutter is a preferred minimum for strength, which limits the angles which can be produced in any final product. Molten plastic is injected into the manufactured orifices in the metal block, and after the plastic cools to adequate hardness, the mold is opened and the manufactured form removed.

“Inlet well” 50 describes the opening, and primary volume in which reagents are deposited and enter the microfluidic cartridge or chip. Direction of fluid flow 8 is the direction that the liquid reagents are impelled through the microchannels within a microfluidic mixing platform when pressure is applied from above inlet well 50. Fluid flow 8 is indicated by small arrows 8.

The term “well step” 51 means the depth change between starting well 50 and microchannel 30, which slows passage of components to be mixed into microchannel 30 until pressure is applied to well 50.

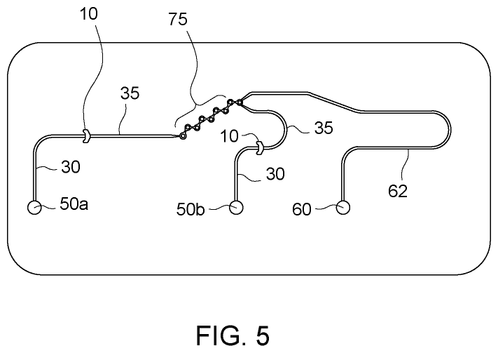

Nanoparticle input well 60 as shown only in FIG. 5 is the point at which, in some embodiments, lipids, surfactants, cholesterol in organic solvent such as ethanol are the components added. No passive capillary valve is needed in microchannel 62 leading from nanoparticle input well 60 to mixing region 75.

Microchannels 30, 35, and 62 are intended to mean linear or curvilinear passages of about typically 80 to 1000 microns width. About 240 microns is standard. In some embodiments, the microchannels are 80 microns to 500 microns wide. In some embodiments, the microchannels are 79 to 499 microns in height.

For ease of manufacture, microchannels are generally rectangular in cross section. In other embodiments, they are square, round, circular, oval, ellipsoid, or semicircular.

The term “minimum radius of curvature” used here means the sharpest turn manufacturable in micro-scale manufacture. For a 0.03 mm cutter, which is the smallest cutter that has durability, the minimum radius is 0.015 to 0.05 mm. In embodiments of the invention, the radius is about 0.08 mm. The achievable minimum radius of curvature is determined by both the cutter used to create the mold, and the properties of the material being molded.

The term “mixing region” 75 is used herein to indicate a downstream portion of the micromixer wherein two or more reagents are combined under pressures adequate to compel reduction in diffusion distance.

Typically, “reagents” are intended to describe fluids containing materials to be mixed: a hydrophobic mixture including neutral lipids, charged or ionizable lipids, polymeric surfactants such as PEG-DMG or Myrj52, and cholesterol; an organic mixture including nucleic acid and ETOH; and aqueous buffer.

A micromixer is a modern technology that uses materials science and hydraulics to achieve high quality, consistent nanoparticles or emulsions for technical and biomedical applications. Micromixers are sold by Precision NanoSystems Inc, Vancouver, Canada.

The term “mixing platform” is intended to mean any component comprised of one or more inlets, microchannels and mixing regions, and one or more outlets. Other terms used in the art are “microfluidic chip” and “microfluidic cartridge”, and these terms along with “mixing platform” are equivalents in this application and are used to describe a body of rigid material, in some embodiments, thermoplastic, with microchannels and other microgeometries as described throughout the invention and in the following references. U.S. Application Pub. Nos. 20120276209 and 20140328759, by Cullis et al. describe methods of using small volume mixing technology and novel formulations derived thereby. U.S. Application Pub. No. 20160022580 by Ramsay et al. describes more advanced methods of using small volume mixing technology and products to formulate different materials. U.S. Application Pub. No. US2016235688 by Walsh, et al. discloses microfluidic mixers with different paths and wells to elements to be mixed. PCT Publication WO/2016/176505 by Wild, Leaver and Walsh discloses microfluidic mixers with disposable sterile paths. PCT Publication No. WO/2017/11647 by Wild, Leaver and Taylor discloses bifurcating toroidal micromixing geometries and their application to micromixing. US Design Nos. D771834, D771833 and D772427 by Wild and Weaver disclose cartridges for microfluidic mixers, which cartridges incorporate earlier versions of “mixing platforms” as described herein.

Mixing platforms often work within a mechanical micromixer referred to in the preceding paragraph, or represented by the embodiments disclosed in PCT Publication No. WO18006166. In other embodiments, a mixing platform can be used in any situation in which pressure is applied to push fluid through the fluid path to mix the contents. Syringes are used in some embodiments. Pumps are used more often. Microfluidic chips and microfluidic cartridges can be considered “mixing platforms” for the purpose of this disclosure.

The term “passive capillary valve” 10 refers to embodiments of the invention, namely a feature which will stop capillary pumping in a hydrophilic m icrochannel.

The term “negative channel turn” (20), as used herein, means a point in the microchannel at which the side wall deviates away from the axis along which the microchannel runs at that point. The deviation encompasses a broader, shaped opening (25) in the microchannel. If the axis of the microchannel is taken as 0 degrees, the angle of the axes of the negative channel turn 20 is at least 90 degrees to about 179 degrees from that axis in some embodiments, from 95 to 160 in some embodiments, from 100 to 150 in other embodiments, from 105 to 145 degrees in other embodiments, from 110 to 140 degrees in other embodiments, from 120 to 130 degrees in other embodiments, and any angle in between. In some embodiments, the negative channel turn is quite angular. In other embodiments, negative channel turn 20 is somewhat rounded.

The term “negative channel volume” 25 refers to the volume of widening in the microchannel 30 that corresponds with the passive capillary valve function according to embodiments of the invention.

The term “normal microchannel transition” (26) is intended to mean the transition from the negative channel volume 25 back to microchannel 35 and typical microchannel dimensions. The exact angle for this transition is not important, although the microchannel wall should return to the microchannel dimensions as efficiently as possible.

The term “nanoparticle” means a particle of between 1 and 500 nm in diameter, and as used herein can comprise an admixture of two or more components, examples being lipids, polymers, surfactants, nucleic acids, sterols, peptides, and small molecules. Examples of nanoparticle technology as well as methods of making them are disclosed in U.S Patent Publications 20120276209A1 by Cullis et al., and US20140328759 by Wild et al.

In this disclosure, the word “comprising” is used in a non-limiting sense to mean that items following the word are included, but items not specifically mentioned are not excluded. It will be understood that in embodiments which comprise or may comprise a specified feature or variable or parameter, alternative embodiments may consist, or consist essentially of such features, or variables or parameters. A reference to an element by the indefinite article “a” does not exclude the possibility that more than one of the elements is present, unless the context clearly requires that there be one and only one of the elements.

In this disclosure the recitation of numerical ranges by endpoints includes all numbers subsumed within that range including all whole numbers, all integers and all fractional intermediates. In this disclosure the singular forms “an”, and “the” include plural elements unless the content clearly dictates otherwise. Thus, for example, reference to a composition containing “a compound” includes a mixture of two or more compounds.

In this disclosure term “or” is generally employed in its sense including “and/or” unless the content clearly dictates otherwise.

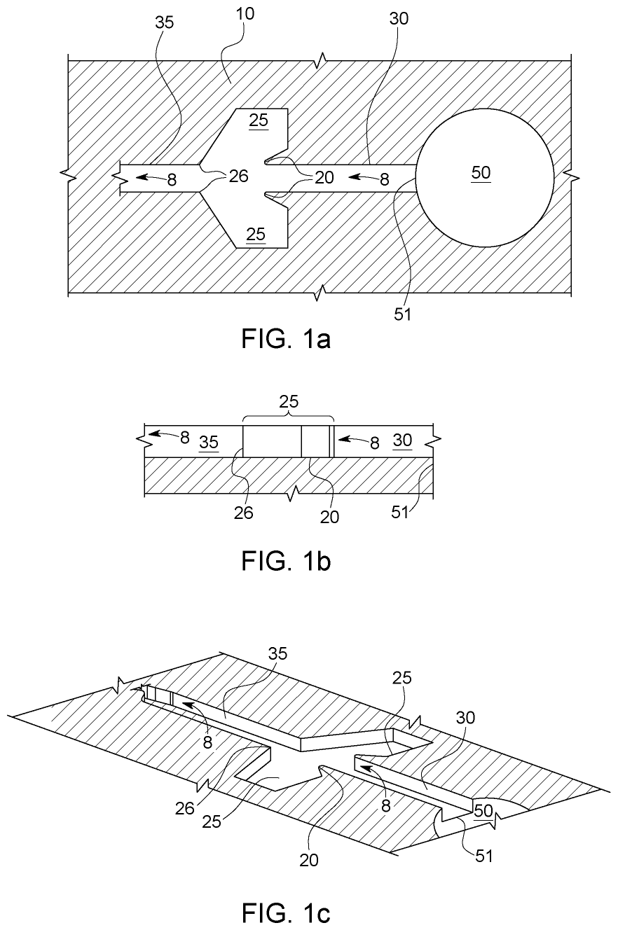

Referring now to the drawings, and more particularly to FIG. 1a, an outline of one embodiment of a passive capillary valve according to the invention is shown in context at 10. The outline of the inlet well 50, well step 51, upstream microchannel 30, passive capillary valve 10, including negative channel turn 20, negative channel volume 25, and normal microchannel transition 26, and downstream microchannel 35, are cavities in bulk 70.

In embodiments of the invention, bulk 70 may be comprised of any rigid or semi-rigid material. In embodiments of the invention, bulk is comprised of thermoplastic or thermoelastomer. In embodiments of the invention, bulk 70 comprises polycarbonate (PC), polypropylene (PP), cyclic oleifin homopolymer (COP), or cyclic oleifin copolymer (COC). In other embodiments, a combination of components makes up bulk 70.

As shown in the FIGS. 1a and 1b, the fluid flow 8 through microchannel 30 precedes passive capillary valve 10, and the fluid flow 8 through microchannel 35 follows it. FIG. 1c is a perspective view of the embodiment shown in FIGS. 1a (top plan view) and 1b (cross sectional side view).

The passive capillary valve 10 is a widening in the microchannel whose shape is designed to stop capillary pumping. The widening must occur at a negative angle with respect to the microchannel. If the axis of the microchannel is 0 degrees, the angle of the axes of the bilateral arms is at least 90 degrees to about 179 degrees from that axis in some embodiments, from 95 to 160 in some embodiments, from 100 to 150 in other embodiments, from 105 to 145 degrees in other embodiments, from 110 to 140 degrees in other embodiments, from 120 to 130 degrees in other embodiments, and any angle in between 90 to 179. The two arms need not be symmetrical. In some embodiments, the negative channel turn has a somewhat rounded shape to a very rounded shape. In some embodiments, the microchannel 30 narrows just prior to the capillary valve 10, with the narrowing forming part of the valve.

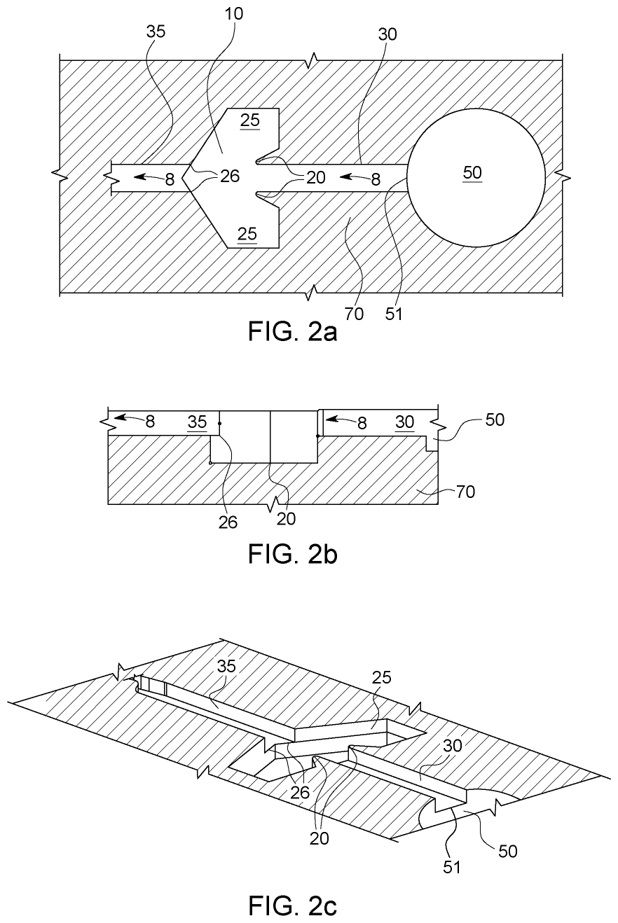

FIGS. 2a, 2b, and 2c represent another embodiment of a passive capillary valve 10 of the invention with more rounded negative channel turn 20. As in the other Figures, fluid flow 8 runs through microchannel 30 towards negative channel turn 20, transitioning through negative channel volume 25, and past normal microchannel transition 26 into subsequent microchannel 35, and downstream to the mixing feature not shown until FIG. 5.

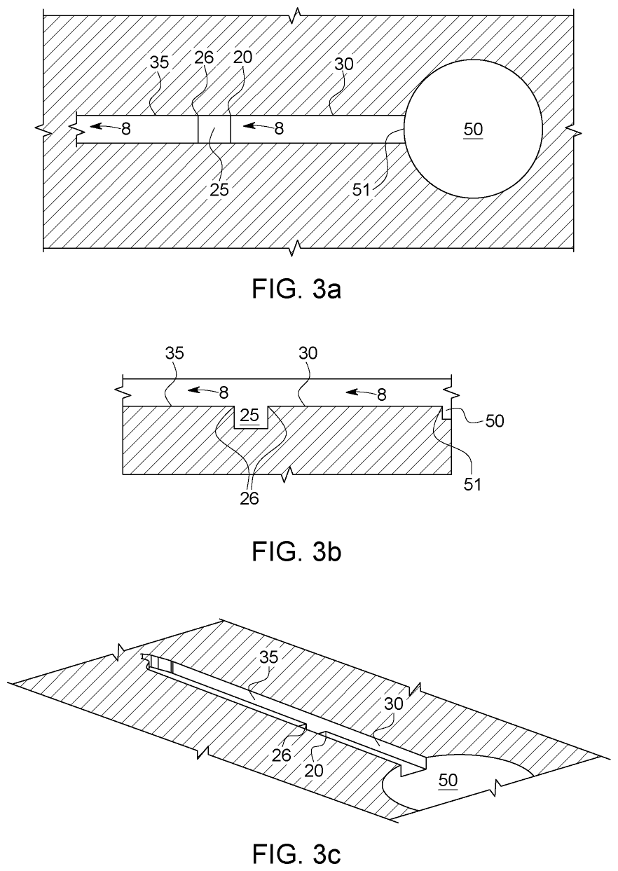

Now referring to FIG. 3a-c, there is shown another embodiment of a passive capillary valve of the invention. This embodiment has a negative channel wall on the “bottom” of the microchannel 30 path only, returning to standard level at microchannel 35. It would be useful in situations of reduced planar room for the “wings” showing in FIGS. 1a and 2a, or where only a very basic passive capillary valve could be used.

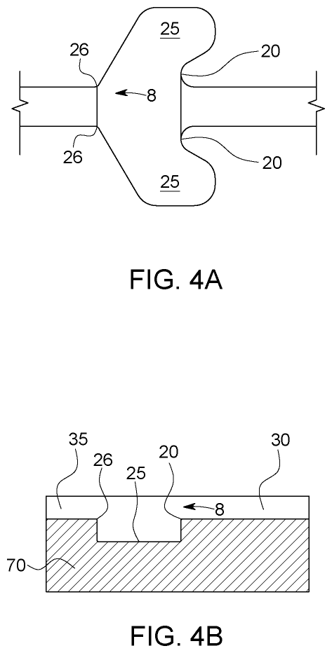

Now referring to FIG. 4a, there is shown exemplary dimensions of one embodiment of a passive capillary valve of the invention. This embodiment corresponds most closely to the one shown in FIGS. 1a-c. The valve is, in preferred embodiments, 1.20 mm at the widest point (latitude) and 0.70 mm long from rearward “wingtip” to normal microchannel transition 26. The valve is 0.50 mm from angle 20 to normal microchannel transition 26. The line marked “6” in FIG. 4a and FIG. 4b is a reference line. FIG. 4a is a top plan view of the embodiment, and FIG. 4b is a side plan cross section.

Now referring to FIG. 5, a mixing platform is shown featuring the passive capillary valves in context. In this embodiment, there are two passive capillary valves according to embodiments of the invention, one along each fluid path between two inlet wells 50a and 50b, and mixing feature 75. Inlet well 50a is charged with buffer, inlet well 50b is charged with aqueous reagents for nanoparticle formulation, such as nucleic acid, and finally nanoparticle output well 60 is loaded with the hydrophobic reagents. No passive capillary valve 10 is needed in microchannel 62 because of the timing of addition, and because the reagents added into 60 are hydrophobic and not subject to capillary action in the same degree. Pressure is applied to the mixing platform inlet well 50b and input well 60. Lipid nucleic acid nanoparticles are formed by the action of the mixing region combined with the emergence into the buffer in inlet well 50a.

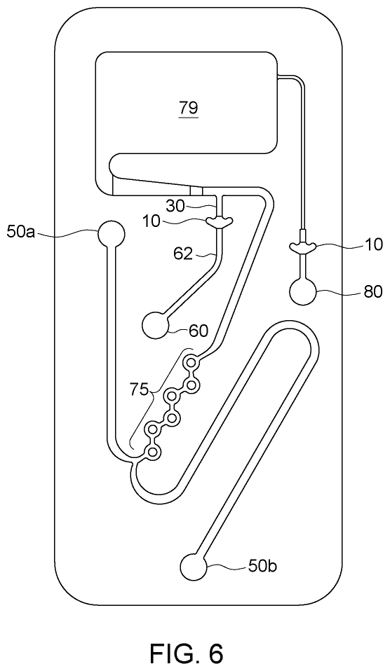

Now referring to FIG. 6, another embodiment of a mixing platform is shown featuring the passive capillary valves in context. In this embodiment, a waste reservoir 79 comes off the post mixer 75 microchannel and leads to vent well 80. The mixing platform enables the tapping of the midstream, optimal, mixture which is diverted to nanoparticle output well 60. Different pressures through the course of the mixing process cause flows through to waste tank 79 to draw off the first volume of mixture, which may not be optimal. Vent well 80 acts as a vent to the atmosphere, enabling the movement of fluid past the turn off to outlet well 60, and capillary valve 10 prevents liquid from advancing out of the mixing platform. Waste reservoir 79 provides a volume for first and/or last volumes from mixing to be removed from the final product. Note that in this embodiment, output well 60 is preceded by capillary valve 10, whereas the inlet wells 50a and 50b do not have capillary valves preceding the mixing region 75.

In another embodiment, capillary valves are present both before and after the mixing region 75. In another embodiment, a capillary valve is present in only one location on the mixing platform.

Operation

As explained above, the passive capillary valves of the invention were necessitated by advances in the field of microfluidic mixing accompanied by a change in manufacturing materials. As microfluidic mixing platforms are being manufactured in greater numbers, PDMS is no longer practical as bulk material. Rigid thermoplastics such as PC, PP, COP, and COP are practical material, but are more hydrophilic than PDMS. The established microchannel geometries that had been used to add and mix components into nanoparticles now demonstrate unwanted capillary pumping.

In capillary pumping, the fluid at the walls of the microchannel will be further ahead than the fluid in the middle of the microchannel, and because fluids tend to adhere to themselves, the body of fluid is pulled forward along the microchannel walls. This tendency erodes consistency in nanoparticle manufacture in a given mixing platform.

As the structures being manufactured are simply too small to make a traditional valve practical, applicants needed to arrive at a different solution. The passive capillary valve 10 was introduced between inlet wells and mixing region 75, in one embodiment. The capillary valve surprising worked at even high pressures of fluid massage down microchannels. Furthermore, it was manufacturable in a mold injection context because of the rounded shoulder angle (referred to as a radius of curvature). In experiments with various aqueous fluids, passive capillary valves in which the microchannel walls a possess a region in which its side walls have a negative angle with respect to the axis of the respective microchannel, unwanted capillary action was prevented even when the angle was not sharp. The capillary valves of the invention 10 even worked to prevent capillary leakage in the extreme example of a mixture of 70% ethanol:30% H₂O.

By way of a real life application, a mixing platform such as the one shown in FIG. 5 is used to formulate nanoparticles comprising siRNA FVII in any suitable nanoparticle blend, for example, one disclosed in US 2016-0022580: 1,17-bis(2-octylcyclopropyl)heptadecan-9-yl-4-(dimethylamino) butanonoate:DSPC:Cholesterol:polyoxyethylene (40) stearate (50:10:37.5:2.5 mol %). Ethanol or an ethanol solution with siRNA is added to a first inlet well 50b. Buffer is added to a second inlet well 50a at the far end of a mixing region 75 from the first inlet well. A nanoparticle blend is added to a nanoparticle input well 60. Pressure is applied on well 60 and central well 50b simultaneously. The fluids in those two wells combine in mixing region 75 and pass through to the buffer in the second inlet well 50a, forming nanoparticles. These are harvested from second inlet well 50a.

In experiments, several variations of the passive capillary valve were tried. A simple widening of the microchannel did not work, nor did a simple constriction. Embodiments shown in FIG. 1a-c and FIG. 2a-c were the most effective with a variety of fluids and mixtures, such as organic solvent and aqueous solutions. The embodiment shown in FIGS. 3a to 3c with a single right angle valve was somewhat effective, but this form would be reserved for situations in which a bilateral embodiment could not fit or be manufactured. In experiments, this embodiment reduced capillary action, but was less robust than the embodiments in FIGS. 1a-c and FIGS. 2a-c.

In experiments involving “sample switching” in the embodiment shown in FIG. 6, capillary valves 10 were used to remove the transient flow at the beginning of a formulation of nanoparticles from the final product. This transient flow is not optimal material and it needed to be syphoned off without benefit of mechanical parts inside the microfluidic mixing platform. As designed, the mixed fluid comes out of the mixing region 75 and travels until it reaches a fork with microchannel 30 in one direction leading to a capillary valve 10, and a forward path leading to a waste reservoir 79 followed by an impedance in the form of a smaller microchannel between waste reservoir 79 and atmosphere (vent well 80). In experiments, the fluid stopped at the capillary valve 10, but proceeded to travel into the reservoir 79, displacing the air in the reservoir 79. The air passed through the impedance microchannel easily, but once the fluid reached the impedance, it caused an increase in backpressure. Once this backpressure was large enough, fluid began to flow through the capillary valve 10 and flowed to the nanoparticle output 60. Thus, the overly dilute, poorly mixed, or uneven pre-flow was removed before entering the final nanoparticle formulation.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A microfluidic mixing platform having a bulk, comprising:
(a) an inlet well,
(b) a microchannel having a length,
(c) a passive capillary valve at a point in said length,
(d) a mixing feature, and
(e) an outlet,
and wherein said passive capillary valve prevents capillary flow along the microchannel.

2. The mixing platform of claim 1, wherein the bulk comprises a rigid matrix capable of machine manufacture.

3. The mixing platform of claim 1, wherein said passive capillary valve comprises a widening of the microchannel at an angle of at least 90 degrees and up to 179 degrees relative to the direction of overall fluid flow in the microchannel.

4. The mixing platform of claim 1, wherein said passive capillary valve comprises a widening of the microchannel at an angle of at least 95 degrees and up to 160 degrees relative to the direction of overall fluid flow in the microchannel.

5. The mixing platform of claim 1, wherein said passive capillary valve comprises a widening of the microchannel at an angle of at least 100 degrees and up to 150 degrees relative to the direction of fluid flow.

6. The mixing platform of claim 1, wherein said passive capillary valve comprises a widening of the microchannel at an angle of at least 105 degrees and up to 145 degrees relative to the direction of fluid flow.

7. The mixing platform of claim 1, wherein said passive capillary valve comprises a widening of the microchannel at an angle of at least 110 degrees and up to 140 degrees relative to the direction of fluid flow.

8. The mixing platform of claim 1, wherein said passive capillary valve comprises a widening of the microchannel at an angle of at least 120 degrees, and up to 130 degrees relative to the direction of fluid flow.

9. The mixing platform of claim 1, wherein said passive capillary valve comprises a widening of the microchannel relative to the direction of fluid flow, and wherein said angle is graduated and has a minimum radius of curvature of from 0.015 to 0.05 mm.

10. The mixing platform of claim 1, wherein said passive capillary valve comprises a widening of the microchannel relative to the direction of fluid flow, and wherein said angle is graduated and has a minimum radius of curvature of about 0.08 mm.

11. The mixing platform of claim 1, wherein said passive capillary valve is plural.

12. The mixing platform of claim 1, wherein said passive capillary valve is upstream from a mixing feature.

13. The mixing platform of claim 1, wherein said passive capillary valve is downstream from a mixing feature.

14. The mixing platform of claim 1, wherein said passive capillary valve is upstream from a mixing feature.

15. A method of preventing back flow in a microfluidic mixing platform, by incorporating a segment of negative microchannel wall at a point in a microchannel.

16. The method of claim 15, wherein said segment of negative microchannel is plural.

17. The method of claim 15, wherein said segment of negative microchannel wall is upstream from a mixing feature.

18. The method of claim 15, wherein said segment of negative microchannel wall is downstream from a mixing feature.
